(19) United States
(12) Patent Application Publication
(10) Pub. No.: US 2005/0071423 A1
(43) Pub. Date: Mar. 31, 2005

(54) System, apparatus, and method for providing Web services on mobile devices

(76) Inventor: Jaakko Rajaniemi, Helsinki (FI)

Correspondence Address: CRAWFORD MAUNU PLLC, Suite 390, 1270 Northland Drive, St. Paul, MN, 55120, US

(21) Appl. No.: 10/673,080

(22) Filed: Sep. 26, 2003

(51) Int. Cl. G06F 15/16

(52) U.S. Cl. 709/203

(57) ABSTRACT

The present disclosure is directed to a system, apparatus, and method for providing Web services from a mobile device. In one configuration, a method involves forming a Web service message at a first network entity. The Web service message is targeted for a mobile terminal. A request is directed to a locator arrangement to assist in processing the Web service message. The Web service message is sent to the mobile terminal utilizing the locator arrangement. The Web service message is sent to the mobile terminal using a mobile services transport protocol and processed at the mobile terminal.

### FIELD OF THE INVENTION

This invention relates in general to Web services, and more particularly, to providing Web services on mobile devices.

### BACKGROUND OF THE INVENTION

The emergence of what are known as “Web services” have been used to extend the World Wide Web's capability by providing dynamic content that is programmatically accessible. Initially, content published on the Web was in the form of static pages that were downloaded to a browser. The browser interpreted the page for display, as well as handling user input to objects such as forms or buttons. Later adaptations to Web servers include providing dynamic content on demand, although this content was still intended for access by Web browsers.

Web services allow information to be accessed in other application domains besides browsers. Web services use the same open and extensible formats that have made Web browsers so useful. As a result, Web services can be powerful tools usable for providing distributed data access in many application domains.

Web services are network-based (particularly Internet-based) applications that perform a specific task and conform to a specific technical format. Web services are represented by a stack of emerging standards that describe a service-oriented, application architecture, collectively providing a distributed computing paradigm having a particular focus on delivering services across the Internet.

Generally, Web services are implemented as self-contained modular applications that can be published in a ready-to-use format, located, and invoked across the World Wide Web. When a Web service is deployed, other applications and Web services can locate and invoke the deployed service. They can perform a variety of functions, ranging from simple requests to complicated business processes.

Web services are typically configured to use standard Web protocols such as Hypertext Transfer Protocol (HTTP), Extensible Markup Language (XML) and Simplified Object Access Protocol (SOAP). HTTP is an application-level protocol commonly used to transport data on the Web. XML is a mechanism to define markup languages. Some markup languages (e.g. XHTML) are used mainly to describe how a document is to be formatted for display. Others, such as SOAP, are used to describe data. SOAP is a markup language for message encapsulation and is typically used to transmit messages that invoke remote procedure calls, return the results from such invocation, or to transmit documents.

Web services are typically available on Internet servers. Because servers are typically set up to listen for incoming HTTP connections, the servers are easily adapted to listen for and process Web service requests. Servers are typically accessed by a well-known identifier, such as a Uniform Resource Locator (URL) that may contain a hostname or Internet Protocol (IP) address. To invoke a Web service, a client needs to know the identifier, the Web service protocol supported by the server (e.g., SOAP), and the procedure to be invoked.

In the standard SOAP-HTTP binding, a SOAP messaging transaction is carried out over a Transmission Control Protocol (TCP) connection from the client to a Web server. When the transaction is carried out over the Internet, the server has an IP address used for sending data to the server. The network routes connection requests to the server, which is setup to accept these requests. The server may have a process running to handle the request, or the server may be configured to start a server process to handle the connection.

Although SOAP and other Web services are usually provided by a dedicated server, any device having an accessible IP address may act as a Web services server. Devices characterized as client machines traditionally have not been configured to accept incoming connections, although such client-side services are becoming more prevalent due to popular applications such as instant messaging and file sharing. Providing client-side services still requires that the client have an accessible identifier such as a hostname and/or IP address, as well as the infrastructure to locate the client and route requests to the client's IP address.

It may be desirable to extend Web services to be served from devices such as mobile terminals. Mobile terminals can provide useful information about the terminal's user, such as location and presence. Mobile terminals can serve Web services to allow this information to be asynchronously accessed by other users or network entities. However, mobile terminals may not have an easily accessible identifier for providing Internet services. While it is possible to support the client side of Web services on mobile terminals, supporting server functionality on mobile terminals is more difficult.

In many cases, it is not possible to directly initiate a connection from an arbitrary network entity to a mobile terminal to invoke a service on the mobile terminal. In mobile operator infrastructures, terminals are not typically IP addressable. It also may be relatively costly to implement an “always on” service to handle connection requests on a small, low powered device. However, numerous benefits may be realized from providing services on mobile devices, since these devices can provide immediate and continuous access to users. As mobile devices become more sophisticated and ubiquitous, providing a way of serving Web services and related content from mobile terminals will be become more important.

### SUMMARY OF THE INVENTION

The present disclosure relates to a system, apparatus, and method for providing Web services by a mobile terminal. In one embodiment of the present invention, a method involves forming a Web service message at a first network entity. The Web service message is targeted for a mobile terminal. A request is directed to a locator arrangement to assist in processing the Web service message. The Web service message is sent to the mobile terminal utilizing the locator arrangement. The Web service message is sent to the mobile terminal using a mobile services transport protocol and processed at the mobile terminal.

In another embodiment of the present invention, a mobile terminal includes a transceiver configured to facilitate exchange of data with the network, and a memory capable of storing at least one of a mobile services transport module and a Web services processing module. A processor is coupled to the memory and the transceiver. The processor is configured by the mobile services transport module to receive Web service messages targeted for the mobile terminal via the transceiver using a mobile services transport protocol and communicate the Web service messages to the Web services processing module. The processor is configured by the Web services processing module to process the Web service messages.

In another embodiment of the present invention, a server arrangement is coupled to a network and used to facilitate communications with a wireless terminal. The server arrangement includes means for receiving a Web service message targeted for the wireless terminal via the network and means for initiating a data session with the wireless terminal. The server arrangement also includes means for sending the Web service message to the wireless terminals via the data session using a mobile services transport protocol selected from a plurality of mobile services transport protocols.

The Web services messages of the various embodiments may include Simple Object Access Protocol (SOAP) message. In more particular embodiments, the mobile services transport protocol may include any of Simple Mail Transport Protocol (SMTP) and Session Initiation Protocol (SIP). In other more particular embodiments, the data sessions may include Wireless Application Protocol Over the Air Push sessions.

### BRIEF DESCRIPTION OF THE DRAWINGS

FIG. 1 illustrates a system environment in which Web services provided from mobile terminals may be employed according to embodiments of the present invention;

FIG. 2 illustrates an example computing arrangement for providing Web services on a mobile device according to embodiments of the present invention;

FIG. 3 is a sequence diagram illustrating a SOAP message exchange using SIP as a mobile services transport protocol according to embodiments of the present invention;

FIG. 4 is a sequence diagram illustrating a SOAP message exchange using SMTP as a mobile services transport protocol according to embodiments of the present invention;

FIG. 5 is a flowchart illustrating processing of a SOAP message received using on a wireless terminal according to embodiment of the present invention;

FIG. 6 is a flowchart illustrating the sending of SOAP messages from a location server to a wireless terminal according to embodiment of the present invention;

FIG. 7 illustrates a computing arrangement for processing of Web service messages according to embodiments of the present invention; and

FIG. 8 illustrates a mobile terminal for processing of Web service messages according to embodiments of the present invention.

### DETAILED DESCRIPTION OF THE INVENTION

In the following description of the example embodiments, reference is made to the accompanying drawings which form a part hereof, and in which is shown by way of illustration various example embodiments in which the invention may be practiced. It is to be understood that other embodiments may be utilized, as structural and operational changes may be made without departing from the scope of the present invention.

Generally, the present disclosure is directed to a system, apparatus, and method for providing Web services from a mobile device. In one example, a mobile device is coupled to a locator arrangement via a wireless network. The locator arrangement receives Web service messages targeted for the mobile devices. The locator arrangement may include a well-known IP address and/or hostname for easy access via a network such as the Internet.

The locator arrangement can include any combination of network nodes or data processing entities that perform locator functions as described herein. For example, a message can be sent to a first node, such as a node arranged for handling a particular web service. The message may then be sent to a general aggregate/mediator node for queuing and/or forwarding. The message may then be received by an entity that can locate and connect to the mobile devices. Any combination of these entities may be considered part of a locator arrangement.

Mobile devices typically do not include addresses locatable from networks such as the Internet. The locator arrangement can receive Web service messages targeted for mobile devices, determine the ultimate target of the messages, and initiate a connection with the target device. The identity of the target mobile device may be included in Web service messages (e.g., in message body or headers), or in any protocol headers used to direct the message to the locator arrangement. In another configuration, the request is sent to a Uniform Resource Locator (URL) that includes an address of the locator arrangement and other data identifying the target mobile device.

The locator arrangement may include a standard transport protocol interface (e.g., HTTP) for receiving Web service communications. The locator arrangement can also package the Web service message in a different, mobile services transport protocol. The Web service messages can then sent to the mobile devices using this mobile services transport protocol.

As referred to herein, the terms “transport protocol” and “mobile services transport protocol” does not necessarily imply a transport layer as defined in models such as the Open System Interconnection (OSI) model. Typically, the term “transport protocol” as used herein refers to message-oriented protocols for transferring data in support of Web service transactions. These protocols typically operate at the application layer of the OSI model.

The mobile devices can include a Web services processing stack that receives Web service messages via the mobile services transport protocol. The mobile device can process the Web service message and provide a response, if needed. The mobile device may use the mobile services transport protocol for sending the response back to the locator node. The locator arrangement can then send the response back to the originator using the standard transport protocol.

In general, mobile devices may utilize various protocols for message transport. Some of the mobile transport protocols are commonly in use on the Internet, and other protocols may be used almost exclusively by mobile devices. For example, although Web services such as SOAP may be transported using a number of protocols, the combination of SOAP over HTTP is by far the most commonly employed arrangement. Using a ubiquitous protocol such as HTTP for Web services is advantageous because this ensures a high level of compatibility across different hardware and software platforms. HTTP is a foundation of the World Wide Web, therefore the protocol's behavior, performance, and reliability has been optimized over the years. However, HTTP was developed in the realm of traditional, wired computer networks, and was not designed to suit the needs of mobile devices.

Even though HTTP was not developed for mobile devices in particular, it is still possible to offer HTTP services on a mobile device. Other legacy protocols may also be adapted to provide transport services on mobile devices, including Simple Mail Transfer Protocol (SMTP), Extended SMTP (ESMTP), File Transfer Protocol (FTP), Blocks Extensible Exchange Protocol (BEEP), Session Initiation Protocol (SIP), etc. There are also a number of service transport protocols implemented with the unique needs of mobile devices in mind, including Wireless Session Protocol (WSP), Simple Message Service (SMS) protocol, etc. It will be appreciated that protocols for providing mobile data transport services may include any number of legacy or future protocols that have been adapted for use on mobile devices.

Mobile devices necessarily have more limitations in terms of processing power, memory, and network bandwidth than non-mobile devices. So, even though mobile device can include any number of transport protocols, it is not likely that any given protocol will widely available on all devices. Unlike general-purpose computers, mobile devices typically incorporate a minimal set of software and services. Therefore it is preferable that systems adapted for providing Web services to mobile devices be flexible in providing a variety of possible transport and network protocols used for direct communications with those devices.

Besides problems caused by mobile devices potentially using different message transport protocols, there are other issues that may inhibit deployment of Web services on mobile devices. For example, the issue of addressability may be an obstacle in providing simple deployment of Web services on mobile devices. Web service providers on the Internet are locatable via an Internet Protocol (IP) address. Just as HTTP has been a dominant message transport protocol of the Web, IP is the dominant network protocol of the Web. The IP address can also be represented by text identifiers (e.g., hostnames). The Internet (or any IP network) can provide mechanisms for mapping hostnames to IP addresses by using directory services such as the Domain Name System (DNS). Networks using IP can also use various routing protocols to locate and deliver data to hosts based on IP addresses.

The nature of mobile devices makes it difficult to provide the devices hostnames or IP addresses for locating the devices via the Internet. Mobile devices work under conditions that greatly affect the ability to easily identify, locate, and send data to the devices using IP. Mobile devices may have to work amongst various network providers/bearers and be able to dynamically switch between base stations during active sessions. Therefore, although mobile devices may be able to provide Web services, it is not trivial to address mobile devices via the Internet.

Use of a locator arrangement can solve issues of addressability and different transport protocols that arise when providing Web services from mobile devices. The locator arrangement can utilize a variety of suitable transport protocols for sending data to mobile devices, as well as using wireless-network-specific protocols for locating and identify mobile devices. Since the locator arrangement can be accessed from the Internet, it can provide a transparent entry point for Internet clients (or any network entities) that is attempting to access Web services served on mobile devices.

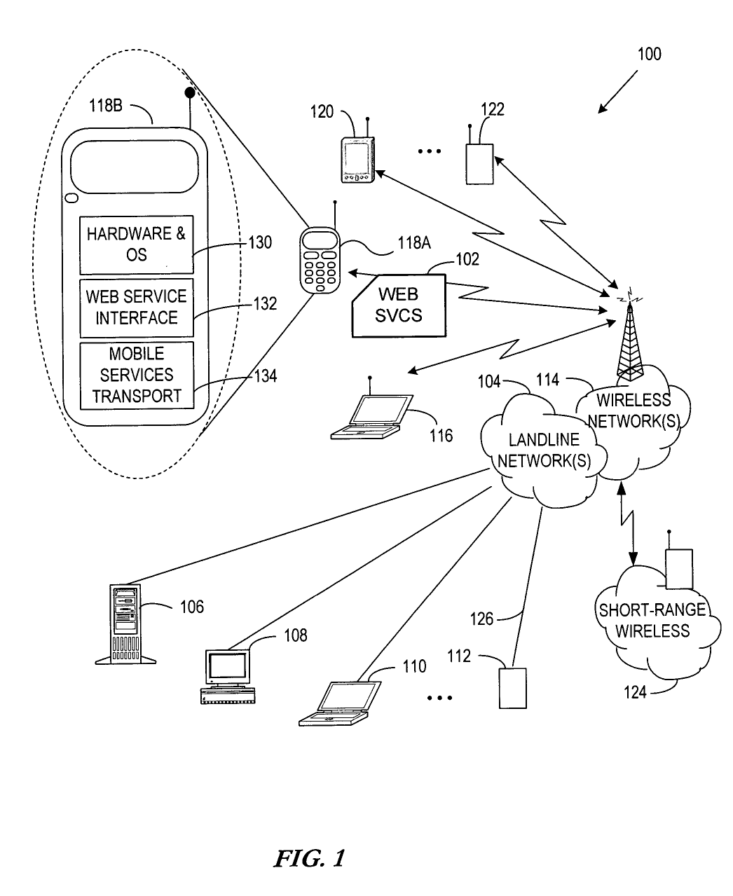

Referring now to FIG. 1, a representative system environment 100 is illustrated in which Web services may be provided on mobile devices according to embodiments of the present invention. In the representative system environment 100, Web service messages 102 may be communicated using a mobile service transport protocol between target devices in any combination of known manners. These manners include via a landline network(s) 104, which may include a Global Area Network (GAN) such as the Internet, one or more Wide Area Networks (WAN), Local Area Networks (LAN), and the like. Any computing device or other electronic device that supports Web services may interact with arrangements according the present invention, such as servers 106, desktop computers 108 or workstations, laptop or other portable computers 110, or any other similar computing device capable of communicating via the network 104, as represented by generic device 112.

In one example, locator functionality can be provided, in whole or in part, by the server 106, also referred to herein as a location server 106. The location server 106 may communicate with mobile devices via one or more wireless networks 114, such as Global System for Mobile Communications (GSM), Universal Mobile Telecommunications System (UMTS), Personal Communications Service (PCS), Time Division Multiple Access (TDMA), Code Division Multiple Access (CDMA), or other mobile network transmission technology. Again, any mobile electronic device can provide Web services via the location server 106, such as laptop or other portable computers 116, mobile phones 118A and other mobile communicators, Personal Digital Assistants (PDA) 120, or any other similar computing device capable of communicating via the wireless network 114, as represented by generic device 122.

A Web service message 102 may also be transferred between devices using short-range wireless technologies 124, such as Bluetooth, Wireless Local Area Network (WLAN), infrared (IR), etc. The message 102 can additionally be distributed using direct wired connections, such as depicted by connection path 126. The present invention is applicable regardless of the manner in which data is provided or distributed across the system environment 100.

An example of a target device that provides Web services is illustrated as the mobile terminal 118B. The mobile terminal 11 8B includes, for example, hardware (including the processor) coupled to an operating system (OS) 130. A Web services module 132 can be configured to process incoming Web service requests, such as the Web service message 102. The Web services module 132 may be enabled to receive incoming Web service requests via a mobile services transport module 134. The mobile services transport module 134 can receive data using sessions initiated by the location server 106 and using the protocols of the transport module 134. These sessions can be used to invoke a procedure of the Web services module 132.

The functional components of the mobile terminal 118B, including the Web services module 132 and mobile services transport modules 134 may be implemented as firmware or as a program running on the OS 130. The Web services module 132 may use any combination of Web service protocols known in the art, including SOAP, XML-RPC, Universal Description, Discovery and Integration (UDDI), and Web Services Description Language (WSDL). Similarly, the mobile services transport module 134 may utilize any combination of mobile services transport protocols, such as SIP, SMTP, FTP, BEEP, etc.

Examples of processing Web service messages may be described herein using specific examples of networking technologies. For example, Web service message exchanges may be described using Simple Object Access Protocol (SOAP) messages. Those skilled in the art will appreciate that the concepts described using example SOAP messaging and processing arrangements are equally applicable to other Web service technologies and protocols, such as XML-Remote Procedure Call (XML-RPC), Java, ActiveX, etc.

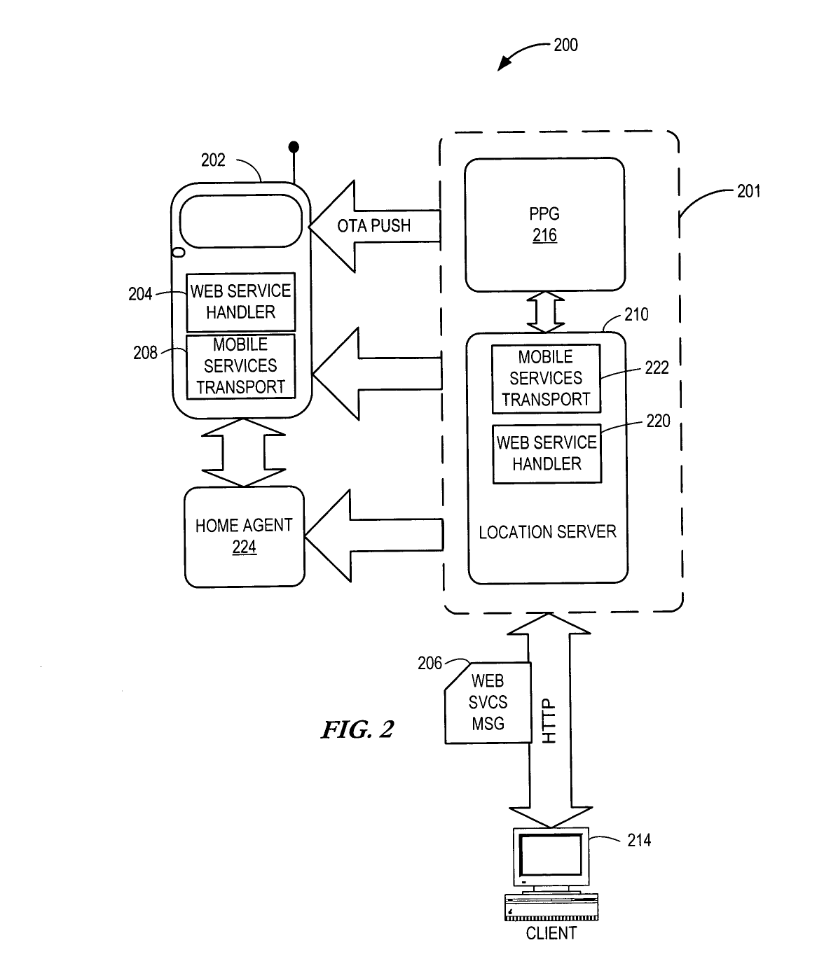

Turning now to FIG. 2, a system 200 is illustrated that may be adapted for providing Web services according to embodiments of the present invention. A mobile terminal 202 includes a Web services handler (e.g., SOAP handler) 204 that is configured to receive an incoming Web services message 206 (e.g., a SOAP message). The mobile terminal 202 includes a mobile services transport handler 208 configured to handle data sessions initiated by a server or other network entity. The mobile services transport handler 208 dispatches the SOAP envelope content of the incoming SOAP message 206 to the SOAP handler 204. Similarly, SOAP response messages can be sent from the SOAP handler 204 to the mobile services transport handler 208. The mobile services transport handler 208 then sends the response message back to the network and targeted for the originator of the SOAP message 206.

The protocol used by the mobile services transport handler 208 allows the mobile terminal 202 to exchange data with a location arrangement 201. The location arrangement 201 may include a location server 210. The location server 210 may be formed from one or more processor arrangements arranged to locate and transfer data to mobile devices. The location server 210 may include a mobile services transport handler 222 for communicating with the mobile services transport handler 208 of the mobile terminal 202. The communications between the location server 210 and mobile terminal 202 may be initiated by the location server 210, or by another entity of the location arrangement 201 such as a Push Proxy Gateway (PPG) 216.

The PPG 216 can initiate data sessions with the mobile terminal 202 using a protocol such as WAP OTA Push. A session initiated using OTA Push may allow binding the session to various mobile services transport protocols. If the location server 210 utilizes the PPG 216 for initiating data sessions with the mobile terminal 202, all data directed to the mobile terminal 202 may be routed through the PPG 216. In such an arrangement, the location server 210 may communicate with the PPG using Push Application Protocol (PAP). PAP is an XML based protocol for describing details of push data delivery (for example, recipient, expiration time, network bearer, etc.).

The use of a location server 210 and/or PPG 210 provides a transparent way for Web services to be invoked on the mobile terminal 202. In the illustrated arrangement 200, SOAP messages may originate on any data processing arrangement, such as a client machine 214 coupled to the arrangement 200 via a mechanism such as a Wide Area Network (WAN) or Local Area Network (LAN) and using a protocol such as HTTP. In a typical Web service arrangement, invoking a SOAP procedure involves sending an XML formatted message from a client to a SOAP server using HTTP. The SOAP server may respond to the SOAP procedure by sending a SOAP response message to the client, also using HTTP.

SOAP messages sent over HTTP are typically addressed to Universal Resource Locators (URLs) that include a hostname or IP address of the SOAP HTTP server. The client 214 may have an identifier that can be used to identify the target (e.g., the mobile terminal 202) for the SOAP message 206. However, the mobile terminal 202 does have a routable address. Therefore, instead of sending the SOAP message 206 directly to the mobile terminal 202, the message 206 can be sent to the location server 210.

The location server 210 includes a Web services handler 220 for handling Web service message exchanges with the client 214. Even though the location server 210 is not the target of the SOAP messages, it acts as a proxy for the target mobile terminal 202. The location server 210 can reformat these Web service messages according to a selected mobile service transport protocol and send the messages to the mobile terminal 202 either directly of via an entity such as the PPG 216.

In one arrangement, the mobile terminal 202 may include capability to communicate using Mobile IP. Under Mobile IP, a home agent 224 may include a statically routable IP address, and the mobile terminal 202 has a changing address, known as a “care of address.” The locator arrangement 201 may be configured to simply send an HTTP/SOAP message to the home agent 224 of the mobile terminal 202. The user can setup the home agent 224 for receiving Web service messages from the locator arrangement 201 and forwarding the message to the terminal 202. The home agent 224 may also be included in the functionality of the locator arrangement 201. In such an arrangement the mobile services transport handler 222 may include the ability to tunnel connections directly to the mobile terminal 202 using the Mobile IP protocol, or indirectly via the home agent 224.

The location server 210 may be in communication with many mobile terminals, so the message transactions between the client 214 and the location server 210 must include additional information to allow the location server 210 to identify the correct mobile terminal 202. In one arrangement, a SOAP message 206 destined for a mobile terminal 202 may use a specially formed URL. The specially formed URL may include an address of the location server 210, or the address of any network entity arranged to work in concert with the location server 210 in sending SOAP requests to mobile terminals. The URL may also include a wireless-network-specific address of the terminal 202.

There are various ways of including a terminal's wireless network address in a URL targeted for the location server 210. In one example, the URL may include the network specific terminal address as a query string in an HTTP POST operation. The query string can be processed using any manner of server side query handler, such as Common Gateway Interface (CGI) or Hypertext Preprocessor (PHP). In another arrangement, the URL could be targeted for a specific TCP port or address path of the location server 210 that is unique for each mobile terminal serviced by the location server 210.

There may be alternate ways of informing the location server 210 of the identity of the target mobile terminal 202. The network-specific terminal address may be included in protocol headers (e.g., HTTP headers) of requests that are sent to the location server 210 or other network entity. In another arrangement, the network-specific terminal address may be embedded in the SOAP message itself.

It will be appreciated that the mobile terminal 202 may regularly connect and disconnect from mobile networks. The terminal 202 may connect to any geographically-located network where compatible services are offered, and the network's location is not predictable. Therefore a mechanism may be required to allow the mobile terminal 202 to advertise its availability to receive Web services via the location service. This may include informing the location arrangement 201 of the terminal's identity and location to enable terminal provided services.

There can be various mechanisms used for initiating terminal services between the mobile terminal 202 and the location arrangement 201. One entity of the location arrangement 201 can be statically associated with a given mobile terminal. In this arrangement, such requests are always directed to a given URL, and the location entity 201 can forward those requests to the appropriate location server 210. The location server 210 itself could be statically mapped to a given terminal 202, however the terminal 202 may be potentially located anywhere in the world, therefore it may not be possible for the location server 210 to initiate a direct connection with the mobile terminal.

In one arrangement, the mobile terminal 202 can register with an entity of the location arrangement 201, such as a local location server 210 associated with the local wireless network. The terminal 202 could register its contact information for Web services with this local location server 210 using a mechanism similar to a SIP REGISTER message. This contact information may include a local network identifier (e.g., address, port), protocols of the Web services (e.g., HTTP/SOAP, SIP/SOAP), an identifier of the terminal (e.g. IMEI), an identifier of the user (e.g. IMSI, MSISDN, SIP URL or usemame associated to the user in the location server), an identifier of the web services hosted in terminal, etc.

The location server 210 can be configured to facilitate the exchange of SOAP messages using the SOAP handler 220 and the mobile services transport handler 222. In one example, the SOAP handler 220 implements a listener for incoming SOAP messages for all mobile terminals handled by the location server 210. The listener may determine the destination terminal's identity by data embedded in the URL, SOAP message, or protocol headers. The location server 210 determines the target mobile terminal 202 based in the identifier, and may select a mobile services transport protocol from a plurality of such protocols based on a profile of the mobile terminal. The location server 210 can then send the request directly to the terminal 202 using the selected mobile services transport protocol. Alternately, the location server 210 may act through another server such as the PPG 216 using a mechanism such as OTA Push, again using the selected mobile services transport protocol.

As described above, the locator arrangement 201 can act as a proxy for the mobile terminal 202 by receiving and forwarding Web service messages. In other configurations, the locator arrangement can be adapted to return network information of the mobile terminal 202 to the originator of the Web service message (e.g., the client 214). This network information may the IP address of terminal, port number of the Web service, protocol to be used, and any other information needed to directly connect to the terminal 202. After receiving this information, the client 214 can send the Web service messages directly to the terminal 202. The client 214 may perform a separate query to the locator arrangement 201 requesting the location of the Web service, or the client 214 can send the Web service message to the locator arrangement 201. In either case, the locator arrangement 201 responds to the client 214 with the information describing address of the Web service.

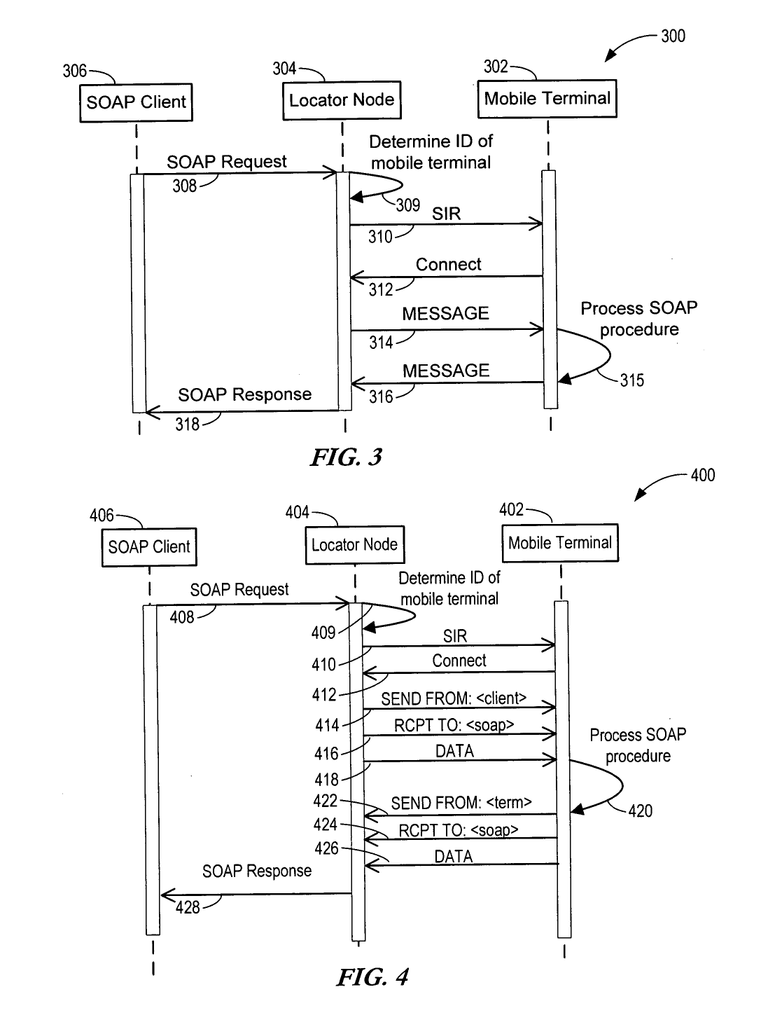

Turning now to FIG. 3, a sequence diagram 300 illustrates one example of performing a SOAP message transaction via SIP. It will be appreciated that some events in the sequence diagram 300, such as SIP response codes, have been omitted for clarity. In this diagram, a mobile terminal 302 is in communication with a locator node 304. A SOAP client 306 invokes a SOAP procedure targeted for the mobile terminal 302. This invocation may occur by sending a SOAP request 308 to the locator node 304 using a specially formatted message or URI that identifies the target terminal. The SOAP request 308 can be sent to the locator node 304 using the standard HTTP POST procedure, with the SOAP request envelope sent as the POST body.

After receiving the SOAP request 308, the locator node 304 determines 309 which terminal the message is targeted for 310. The locator node 304 can then initiate a session using a session initiation request (SIR) 310 targeted for the mobile terminal 302. The SIR 310 is a mechanism defined within WAP to establish sessions with mobile terminals. It will be appreciated that the SIR 310 may be accomplished using other mechanisms besides those identified in the WAP standards to initiate sessions with mobile terminals.

In response to the SIR 310, the mobile terminal sends a connect response 312 to the locator node 304 to confirm establishment of the session. Once the session is established, the locator node 304 can send a SIP MESSAGE 314 to the mobile terminal 302 containing the SOAP envelope in order to invoke the SOAP procedure. The mobile terminal 302 processes 315 the SOAP procedure and supplies a SIP MESSAGE 316 containing the SOAP response to the locator node 304. The locator node 304 the responds in kind with a SOAP response 318 to the client 306.

A similar exchange may be used to implement SOAP using SMTP. In reference now to FIG. 4, a sequence diagram 400 includes a mobile terminal 402 in communication with a locator node 404. The mobile terminal 402 is configured to accept incoming SMTP requests. The SMTP requests can be used to transfer the SOAP envelope of the request in an SMTP message body.

It will be appreciated that some events in the sequence diagram 400, such as SMTP response codes, have been omitted for clarity. A SOAP client 406 invokes a SOAP procedure targeted for the mobile terminal 402 by sending a SOAP request 408 to the locator node 404. The locator node 404 determines 409 the identity of the target terminal and sends a SIR 410 to the mobile terminal 402. The mobile terminal responds with a connect 412.

After the mobile terminal 402 has communicated the session connect 412, the locator node 404 begins sending the SOAP request via SMTP using SEND 414 and RCPT 416 commands. The target application of the request (e.g., SOAP processing stack) can be indicated either by using a special address in the “TO:” portion of the RCPT command 416, or within the message itself. The message may indicate that the data is destined for the SOAP processing stack, for example, by a Content-Type header entry.

The SEND command 414 is intended for sending messages direct to a terminal, and can be optionally implemented in SMTP. The SOAP processing stack of the mobile terminal 402 can act as a user terminal process that is arranged for processing of incoming SMTP SEND messages. Other SMTP commands may also be used in SMTP data transfers, including MAIL, SOML, and SAML.

After the prerequisite SEND 414 and RCPT 416 commands have been sent, the locator node 404 sends the SOAP envelope using the DATA command 418. The SOAP envelope can be received at the SOAP processing stack and processed 420. Since SOAP requests usually involve the sending of a SOAP response, this may be accomplished using SMTP from the mobile terminal 402 to the locator node 404 using a similar sequence of SEND 422, RCPT 424, and DATA 426 commands.

It will be appreciated that the locator node 404 may maintain multiple, simultaneous SOAP transactions with the terminal 402. Therefore the RCPT request 424 and/or DATA command 426 should indicate that the request is intended for the SOAP processing stack of the locator node 404, as well as providing the address of the SOAP client 406. Once the locator node 404 receives the SOAP envelope from the DATA command 426, the envelope can be used to form a standard SOAP response message 428 sent to the SOAP client 406.

Although the diagrams in FIGS. 3 and 4 describe specific examples of Web service processing using SIP and SMTP as transport protocols. It will be appreciated that various alternate SIP and SMTP method can be used to accomplish similar results. Also, it will be appreciated that the concepts described in relation to FIGS. 3 and 4 may be applied to other transport protocols. For example, a mobile terminal could implement a File Transfer Protocol (FTP) server. The FTP PUT and GET commands could be used to send data back and forth between the mobile terminals and locator nodes.

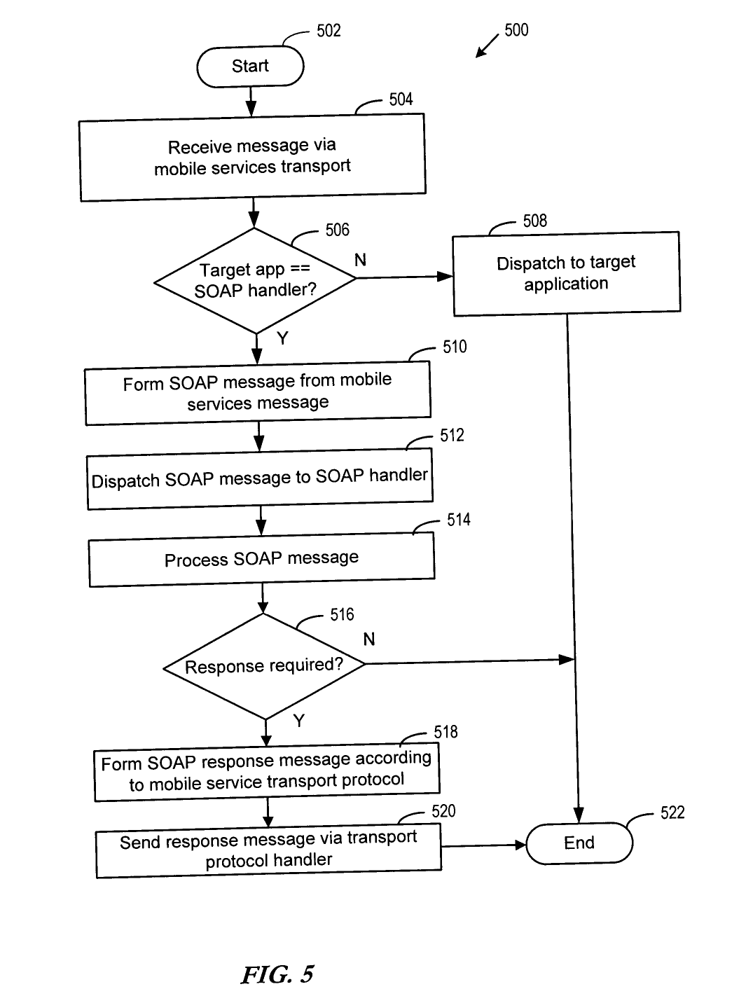

Various functional modules within the mobile terminals may control SOAP transactions between network entities and mobile terminals. An example of how a mobile terminal might handle an incoming SOAP message over mobile services transport protocol is illustrated in the flowchart 500 of FIG. 5. The routine begins (502) with the mobile services transport handler of the mobile terminal receiving (504) a message. The message may be received using various transport protocols, such as SMTP, SIP, FTP, etc. The mobile terminal determines (506) whether the target application for the push message is the SOAP handler.

There may be various ways of determining (506) whether the SOAP handler is the message's target application. The message may include an application identifier in a message header or in the message body. The application identifier can be used in directing the incoming data to the appropriate handler application. An application identifier can be assigned to the SOAP handler application, so that dispatching the message involves examining the identifier of the incoming message to see whether it matches the SOAP handler identifier. In other arrangements, the message application identifier may include the identifier of an existing application. This existing application can dispatch the message to the SOAP handler based on a header field such as “Content-Type”.

If the incoming push message is not meant for the SOAP handler, it can be dispatched (508) to the appropriate handler application by the usual mechanisms. If the incoming message is targeted for the SOAP handler application, then a SOAP message can be formed (510) from the message body. Forming (510) the SOAP message may involve at least stripping off lower-level protocol headers or other data. The SOAP message then dispatched (512) to the handler, which processes (514) the message. If a response is required (516), then the SOAP handler can form (518) a SOAP response message according to the appropriate mobile services transport protocol. This SOAP response message can be sent (520) to the network via the mobile services transport protocol, and the procedure is complete (522).

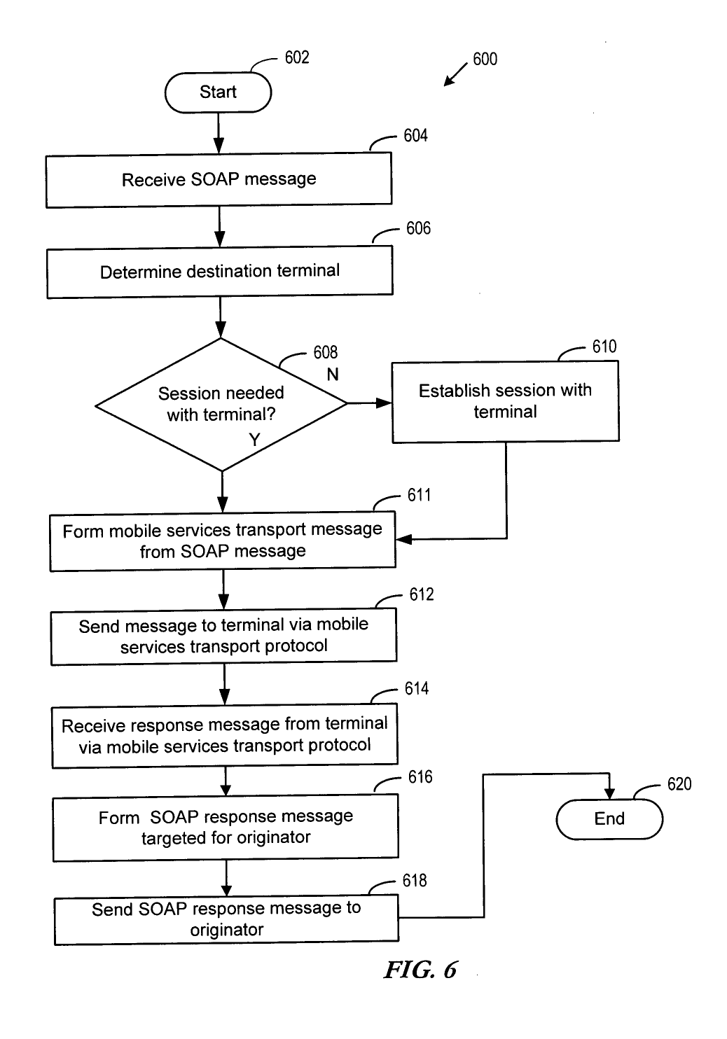

Referring now to FIG. 6, a flowchart 600 illustrates one procedure that may be used by a locator node and various other server entities in sending Web service (e.g., SOAP) messages to a mobile terminal according to embodiments of the present invention. The procedure begins (602) with the receiving (604) of a Web service message. The Web service message may be received using standard protocols, such as using an HTTP request directed to the locator node. The destination mobile terminal is determined (606) based on the SOAP message URL or other data in the message. Determining (606) the destination mobile terminal may also involve choosing a mobile services transport protocol from a plurality of mobile services transport protocol. The locator node may use any number of mobile services transport protocols when facilitating Web services for a plurality of terminals.

If a session is needed (608) with the mobile terminal, the session can be established (610) using a SIR or other suitable mechanism. It will be appreciated that the locator node may establish (610) session itself or by the use of another network entity such as a Push Proxy Gateway (PPG). If a PPG is used, then data sent to the mobile terminal may be forwarded through the PPG.

Once the session has been established (610), the locator node can form (611) a message from the SOAP message according to the requirements of the selected mobile services transport protocol. Forming (611) the message may involve adding protocol headers and changing the format of some of the data according to the syntax and grammar of the selected protocol. The message is then sent (612) to the mobile terminal using the selected mobile services transport protocol. A response message may be received (614) from the mobile terminal using the selected mobile services transport protocol. A SOAP response message can be formed (616) from the terminal response message, and the SOAP response message is sent (618) to the originator of the SOAP request, after which the routine is complete (620).

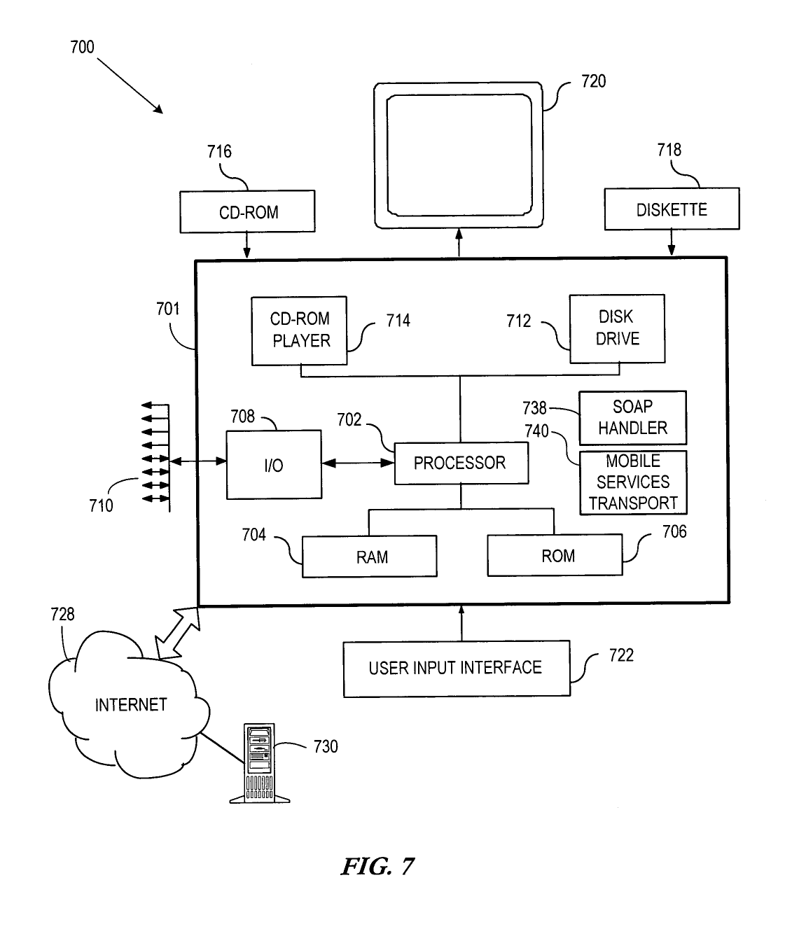

Turning now to FIG. 7, an example computing structure 700 is illustrated that is suitable for performing messaging activity in accordance with embodiments of the present invention. The computing structure 700 includes a computing arrangement 701. The computing arrangement 701 may act a server, client, gateway, proxy, or any other network entity for delivering Web service requests to mobile client. The computing arrangement 701 includes a central processor (CPU) 702 coupled to random access memory (RAM) 704 and read-only memory (ROM) 706. The ROM 706 may also be other types of storage media to store programs, such as programmable ROM (PROM), erasable PROM (EPROM), etc. The processor 702 may communicate with other internal and external components through input/output (I/O) circuitry 708 and bussing 710, to provide control signals and the like. For example, processing of SOAP messages may be performed by the computing arrangement 701 at a SOAP handling module 738. The SOAP handling module 738 can communicate SOAP messages with a mobile services transport module 740. The mobile services transport module 740 can process Web service message exchanges Web using one or more selectable transport protocols.

External data storage devices, such as databases, may be coupled to I/O circuitry 708 to facilitate messaging functions according to the present invention. Alternatively, such databases may be locally stored in the storage/memory of the server 701, or otherwise accessible via a local network or networks having a more extensive reach such as the Internet 728. The processor 702 carries out a variety of functions as is known in the art, as dictated by software and/or firmware instructions.

The computing arrangement 701 may also include one or more data storage devices, including hard and floppy disk drives 712, CD-ROM drives 714, and other hardware capable of reading and/or storing information such as DVD, etc. In one embodiment, software for carrying out the messaging operations in accordance with the present invention may be stored and distributed on a CD-ROM 716, diskette 718 or other form of media capable of portably storing information. These storage media may be inserted into, and read by, devices such as the CD-ROM drive 714, the disk drive 712, etc. The software may also be transmitted to computing arrangement 701 via data signals, such as being downloaded electronically via a network, such as the Internet 728. The computing arrangement 701 may be coupled to a display 720, which may be any type of known display or presentation screen, such as LCD displays, plasma display, cathode ray tubes (CRT), etc. A user-input interface 722 may be provided, including one or more user interface mechanisms such as a mouse, keyboard, microphone, touch pad, touch screen, voice-recognition system, etc.

The computing arrangement 701 may be coupled to other computing devices, such as a server 730, via a network, for Web service messaging. The server 730 may be part of a larger network configuration as in a global area network (GAN) such as the Internet 728, which allows connections to the various landline and/or mobile devices.

Providing Web services from mobile devices may be advantageous in many applications. The mobile devices may be any type of wireless device, such as wireless/cellular telephones, personal digital assistants (PDAs), or other wireless handsets, as well as portable computing devices capable of wireless communication. These landline and mobile devices utilize computing circuitry and software to control and manage the conventional device activity as well as the message functionality as described herein. Hardware, firmware, software or a combination thereof may be used to perform the various Web service messaging functions described herein.

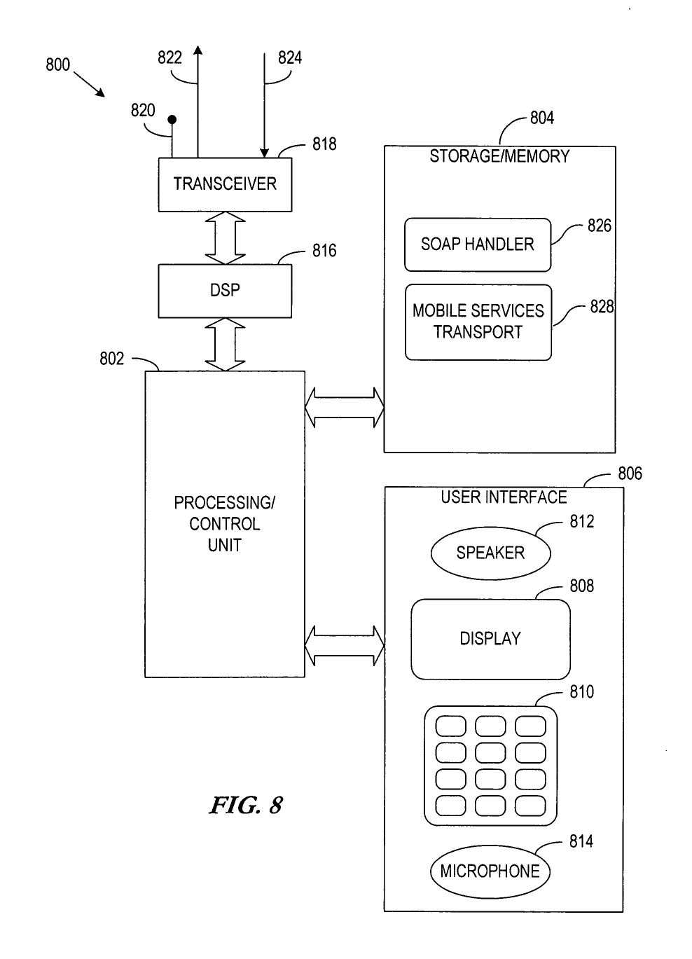

An example of a representative mobile computing arrangement capable of carrying out operations in accordance with embodiments of the invention is illustrated in FIG. 8. Those skilled in the art will appreciate that the exemplary mobile terminal 800 is merely representative of general functions that may be associated with such mobile devices, and also that landline computing systems similarly include computing circuitry to perform such operations.

The mobile terminal 800 is suitable for providing Web service communications using a mobile services transport protocol in accordance with embodiments of the present invention. The representative mobile terminal 800 includes a processing/control unit 802, such as a microprocessor, reduced instruction set computer (RISC), or other central processing module. The processing unit 802 need not be a single device, and may include one or more processors. For example, the processing unit may include a master processor and associated slave processors coupled to communicate with the master processor.

The processing unit 802 controls the basic functions of the mobile terminal, and also those functions associated with the present invention as dictated by the SOAP messaging module 826 and mobile services transport module 828 available in the program storage/memory 804. Thus, the processing unit 802 may be capable of sending and receiving messages using the SOAP messaging module 826 in conjunction with the mobile services transport module 828. The mobile services transport module 828 may be arranged to exchange messages with a locator node or other network entity (e.g., PPG) and communicate these messages with the SOAP messaging module 826.

The program storage/memory 804 may also include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc.

In one embodiment of the invention, the program modules associated with the storage/memory 804 are stored in non-volatile electrically-erasable, programmable ROM (EEPROM), flash ROM, etc. so that the information is not lost upon power down of the mobile terminal. The relevant software for carrying out mobile terminal operations and operations in accordance with the present invention may also be transmitted to the mobile terminal 800 via data signals, such as being downloaded electronically via one or more networks, such as the Internet and an intermediate wireless network(s).

The processor 802 is also coupled to user-interface 806 elements associated with the mobile terminal. The user-interface 806 of the mobile terminal may include, for example, a display 808 such as a liquid crystal display, a keypad 810, speaker 812, and microphone 814. These and other user-interface components are coupled to the processor 802 as is known in the art. Other user-interface mechanisms may be employed, such as voice commands, switches, touch pad/screen, graphical user interface using a pointing device, trackball, joystick, or any other user interface mechanism.

The mobile terminal 800 also includes conventional circuitry for performing wireless transmissions. A digital signal processor (DSP) 816 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 818, generally coupled to an antenna 820, transmits the outgoing radio signals 822 and receives the incoming radio signals 824 associated with the wireless device.

The mobile terminal 800 of FIG. 8 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc.

Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a messaging system, apparatus, and method in accordance with the present invention.

The foregoing description of the various embodiments of the invention has been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

1. A method comprising:
forming a Web service message at a first network entity, the Web service message targeted for a mobile terminal;
directing a request to a locator arrangement to assist in processing the Web service message;
sending the Web service message to the mobile terminal utilizing the locator arrangement, the Web service message sent to the mobile terminal using a mobile services transport protocol; and
processing the Web service message at the mobile terminal.

2. The method according to claim 1, wherein the Web service message includes a Simple Object Access Protocol (SOAP) message.

3. The method according to claim 1, wherein the mobile services transport protocol comprises a Hypertext Transfer Protocol (HTTP).

4. The method according to claim 1, wherein the mobile services transport protocol comprises a Session Initiation Protocol (SIP).

5. The method according to claim 1, wherein the mobile services transport protocol comprises a Simple Mail Transport Protocol (SMTP).

6. The method according to claim 1, further comprising registering a web service of the mobile terminal with the locator arrangement.

7. The method according to claim 6, wherein sending the Web service message to the mobile terminal utilizing the locator arrangement comprises determining an address of the mobile terminal based the registration of the mobile terminal with the locator arrangement.

8. The method according to claim 1, wherein sending the Web service message to the mobile terminal utilizing the locator arrangement comprises determining an address of the mobile terminal based on an identifier of the mobile terminal included in the Web service message.

9. The method according to claim 1, wherein sending the Web service message to the mobile terminal utilizing the locator arrangement comprises determining an address of the mobile terminal based on a Universal Resource Identifier (URI) associated with the locator arrangement.

10. The method according to claim 1, wherein directing the request to the locator arrangement for processing the Web service message comprises directing the Web service message to the locator arrangement, and wherein sending the Web service message to the mobile terminal utilizing the locator arrangement comprises sending the Web service message via the locator arrangement to the locator terminal.

11. The method according to claim 10, wherein sending the Web service message via the locator arrangement to the mobile terminal comprises initiating a session between the locator arrangement and the mobile terminal using a Wireless Application Protocol Over The Air Push.

12. The method according to claim 1, wherein directing the request to the locator arrangement for processing the Web service message comprises requesting an address of the mobile terminal from the locator arrangement, and wherein sending the Web service message to the mobile terminal utilizing the locator arrangement comprises sending the Web service message to the mobile terminal using the address of the mobile terminal provided from the locator arrangement.

13. A system for providing Web services from a mobile terminal, comprising:
means for receiving a request for processing a Web services message via a network, the Web service message targeted for a mobile terminal;
means for determining a location of the mobile terminal based on the request;
means for sending the message to the mobile terminal using a mobile services transport protocol based on the location of the mobile terminal; and
means for processing the Web service request message at the mobile terminal.

14. The system according to claim 13, wherein the Web service message includes a Simple Object Access Protocol (SOAP) message.

15. The system according to claim 13, wherein the mobile services transport protocol comprises a Session Initiation Protocol (SIP).

16. The system according to claim 13, wherein the mobile services transport protocol comprises a Simple Mail Transport Protocol (SMTP).

17. The system according to claim 13, further comprising means for establishing a Wireless Application Protocol Over the Air Push session with the mobile terminal for sending the message to the mobile terminal.

18. The system according to claim 13, further comprising:
means for forming a Web service response message at the mobile terminal in response to the Web service request message; and
means for transmitting the Web service response message from the mobile terminal using the mobile services transport protocol.

19. A mobile terminal wirelessly coupled to a network, comprising:
a transceiver configured to facilitate exchange of data with a locator arrangement via the network;
a memory capable of storing at least one of a mobile services transport module and a Web services processing module; and
a processor coupled to the memory and the transceiver, the processor configured by the mobile services transport module to receive Web service messages targeted for the mobile terminal via the locator arrangement using a mobile services transport protocol and communicate the Web service messages to the Web services processing module, the processor configured by the Web services processing module to process the Web service messages.

20. The mobile terminal according to claim 19, wherein the Web service messages include Simple Object Access Protocol (SOAP) messages.

21. The mobile terminal according to claim 19, wherein the mobile services transport protocol comprises a Session Initiation Protocol (SIP).

22. The mobile terminal according to claim 19, wherein the mobile services transport protocol comprises a Simple Mail Transport Protocol (SMTP).

23. A computer-readable medium having instructions stored thereon which are executable for providing Web services on a mobile terminal by performing steps comprising:
receiving a request from a locator arrangement to establish a data session using a mobile services transport protocol;
initiating the data session with the locator arrangement in response to the request;
receiving an incoming message formatted according to the mobile services transport protocol from via the data session;
forming a Web service message from the incoming message; and
processing the Web service message at the mobile terminal.

24. The computer readable medium according to claim 23, wherein the Web service message includes a Simple Object Access Protocol (SOAP)message.

25. The computer readable medium according to claim 23, wherein the mobile services transport protocol comprises a Session Initiation Protocol (SIP).

26. The computer readable medium according to claim 23, wherein the mobile services transport protocol comprises a Simple Mail Transport Protocol (SMTP).

27. The computer readable medium according to claim 23, wherein the data session comprises a Wireless Application Protocol Over the Air Push session.

28. A server arrangement coupled to a network and configured to facilitate communications with a wireless terminal, comprising:
means for receiving a Web service message targeted for the wireless terminal via the network;
means for initiating a data session with the wireless terminal; and
means for sending the Web service message to the wireless terminals via the data session using a mobile services transport protocol selected from a plurality of mobile services transport protocols.

29. The server arrangement according to claim 28, wherein the Web service message includes a Simple Object Access Protocol (SOAP) message.

30. The server arrangement according to claim 28, wherein the mobile services transport protocol comprises a Session Initiation Protocol (SIP).

31. The server arrangement according to claim 28, wherein the mobile services transport protocol comprises a Simple Mail Transport Protocol (SMTP).

32. The server arrangement according to claim 28, wherein the data session comprises a Wireless Application Protocol Over the Air Push session.

33. The server arrangement according to claim 28, further comprising:
means for receiving a Web service response message from the wireless terminal using the mobile services transport protocol; and
means for communicating the Web service response messages to an originator of the Web service message via the network.
